(19) United States
(12) Patent Application Publication
(10) Pub. No.: US 2026/0186139 A1
(43) Pub. Date: Jul. 2, 2026

(54) UNDERWATER DETECTION DEVICE, AND UNDERWATER DETECTION DEVICE CONTROL METHOD

(71) Applicant: Furuno Electric Co., Ltd., Nishinomiya (JP)

(72) Inventors: Keita TAKARIKI, Nishinomiya (JP); Daisuke NISHIKUBO, Takarazuka (JP); Hiromune MATSUMOTO, Nishinomiya (JP)

(21) Appl. No.: 19/545,319

(22) Filed: Feb. 20, 2026

Related U.S. Application Data
(63) Continuation of application No. PCT/JP2024/028286, filed on Aug. 7, 2024.

(30) Foreign Application Priority Data
Aug. 31, 2023 (JP) 2023-140799

(51) Int. Cl. G01S 15/96; G01S 7/52; G01S 15/89

(52) U.S. Cl. CPC G01S 15/96; G01S 7/5202; G01S 7/52026; G01S 7/5205; G01S 7/52053; G01S 15/8911

(57) ABSTRACT

To provide an underwater detection device capable of operating an ultrasonic transducer with a target transmission power even when the transmission power of the ultrasonic transducer is set small, the underwater detection device is provided with: a control circuit configured to generate a control pulse and output the control pulse, repeatedly; a transmitting circuit configured to generate a transmitting current in accordance with the control pulse and provide the transmitting current to the ultrasonic transducer; and a transmission current measurement circuit configured to measure the transmitting current. The control circuit is further configured to: acquire the actual envelope waveform depending on the envelope of the ultrasonic wave outputted from the transducer, based on the measured transmitting current, and correct the pulse width of the control pulse to suppress the difference between the actual envelope waveform and the ideal envelope waveform obtained, based on the ideal transmitting current.

### CROSS-REFERENCE TO RELATED APPLICATION

This application is a continuation application of PCT International Application No. PCT/JP2024/028286, which was filed on Aug. 7, 2024, and which claims priority to Japanese Patent Application No. JP 2023-140799 filed on Aug. 31, 2023, the entire disclosures of each of which are herein incorporated by reference for all purposes.

### TECHNICAL FIELD

The purpose of this disclosure relates to an underwater detection device for detecting an underwater state, a method for controlling the underwater detection device, and a program for causing a control circuit of the underwater detection device to execute a predetermined function.

### BACKGROUND

Conventionally, underwater detection device for detecting underwater conditions is known. In an underwater detection device, an ultrasonic transducer sends ultrasonic waves (transmission waves) into the water, and receives the reflected waves. Echo data, corresponding to the intensity of the received reflected waves, is generated, and an echo image is displayed based on the generated echo data.

In this kind of underwater detection device, for example, processing is performed to modulate amplitude of a plurality of transmission waves transmitted in one wave transmission period while maintaining frequency of these waves constant. Thus, for example, the influence of frequency components other than fundamental waves may be suppressed. Alternatively, for example, processing is performed to modulate the amplitude of the plurality of transmission waves while modifying the frequency of the transmission waves. Thus, range sidelobe generated in a received signal may be suppressed.

According to the above example, spread of a frequency spectrum of a transmission signal is suppressed by weighting burst signals having different frequencies. Therefore, an isolation between signals may be sufficiently secured, and as a result, the transmission period of the signal may be shortened to increase a number of transmissions and improve a display speed. However, in an underwater detection device, it is required to display an echo image as clearly as possible.

The inventor has found that divergence of an envelope waveform of a transmission wave from an ideal envelope waveform is one of the factors that cause the echo image to be blurred in this kind of underwater detection device. Furthermore, the divergence between the envelope waveform of the transmission wave and the ideal envelope waveform may be caused by various factors.

One of the factors is that an impedance of a transmitting circuit and an ultrasonic transducer usually changes depending on the frequency of the transmission signal. That is, when the frequency of the transmission wave is modulated as described above, the envelope waveform of the transmission wave is distorted due to the change in the impedance. Even when the frequency of the transmission wave is constant, the envelope waveform of the transmission wave may be distorted due to response characteristics of the transmitting circuit.

### SUMMARY

In view of such factors, it is an object of this disclosure to provide an underwater detection device, a method, and a program for controlling the underwater detection device capable of suppressing deviation of the envelope waveform of the transmission wave from the ideal envelope waveform.

A first aspect of this disclosure relates to an underwater detection device. The underwater detection device includes a control circuit for outputting a control pulse, a transmitting circuit for supplying a transmission current corresponding to the control pulse to an ultrasonic transducer, and a transmission current measurement circuit for measuring the transmitting current supplied to the ultrasonic transducer. The control circuit acquires a waveform corresponding to the envelope of the transmission wave outputted from the ultrasonic transducer based on the transmitting current measured by the transmission current measurement circuit and executes correction of the pulse width of the control pulse, thereby suppressing the difference between the acquired actual envelope waveform and the ideal envelope waveform.

The envelope waveform of the transmitting current is a waveform corresponding to the transmission wave that is being transmitted. Therefore, the actual envelope waveform of the transmission wave may be obtained from the transmitting current. According to the underwater detection device of the above embodiment, the pulse width of the control pulse is corrected in a way that the difference between the actual envelope waveform and the ideal envelope waveform obtained from the transmitting current is suppressed. Therefore, the envelope waveform of the transmission wave transmitted from the ultrasonic transducer may be approximated to the ideal envelope waveform.

A second aspect of this disclosure relates to a method for controlling an underwater detection device comprising a transmitting circuit for supplying a transmission signal corresponding to a control pulse to an ultrasonic transducer, and a transmission current measurement circuit for measuring the transmitting current supplied to the ultrasonic transducer. The control method according to this aspect acquires a waveform corresponding to the envelope of a transmission wave outputted from the ultrasonic transducer based on the transmitting current measured by the transmission current measurement circuit and executes correction of the pulse width of the control pulse, thereby suppressing the difference between the acquired actual envelope waveform and the ideal envelope waveform.

According to the control method according to this aspect, the same effects as those of the first aspect may be achieved.

The effect and significance of this disclosure will become more clear from the following description of the embodiments. However, the embodiments shown below are merely examples for implementing this disclosure, and this disclosure is not limited to the embodiments described below.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 is a diagram showing a state of use of a fish finder according to an embodiment.

FIG. 2 is a block diagram showing the configuration of the fish finder according to the embodiment.

FIG. 3 is a diagram showing a configuration of a transmitting circuit according to an embodiment.

FIG. 4 is a graph schematically showing the relationship between the waveform (ideal waveform) of the window function and the pulse width of the control pulse according to the embodiment.

FIG. 5 is a flowchart showing a process for correcting the pulse width of the control pulse according to the embodiment.

FIGS. 6A and 6B are graphs showing an example of a waveform acquired in a corresponding step of the flowchart of FIG. 5 according to the embodiment.

FIGS. 7A and 7B are graphs showing an example of a waveform acquired in a corresponding step of the flowchart of FIG. 5 according to the embodiment.

FIGS. 8A and 8B are graphs showing an example of a waveform acquired in a corresponding step of the flowchart of FIG. 5 according to the embodiment.

FIGS. 9A and 9B are graphs showing an example of a waveform acquired in a corresponding step of the flowchart of FIG. 5 according to the embodiment.

FIGS. 10A and 10B are graphs showing an example of a waveform acquired in a corresponding step of the flowchart of FIG. 5 according to the embodiment.

FIG. 11A is a graph showing an example of a waveform of data after normalization processing acquired by processing for the next transmission period when correction is performed in a corresponding step of the flowchart of FIG. 5 according to the embodiment. FIG. 11B is a graph showing a waveform of data after normalization processing obtained by the correction processing of FIG. 5, a waveform of data after normalization processing before correction, and an ideal envelope waveform (window function waveform) according to the embodiment.

FIGS. 12A and 12B are graphs showing a waveform of data after normalization processing obtained by the correction processing of FIG. 5, a waveform of data after normalization processing before correction, and an ideal envelope waveform (window function waveform) according to the embodiment of a transmission wave (CW wave) having a constant frequency and a transmission wave (FM wave) having a modulated frequency, respectively.

FIG. 13 is a graph showing a verification result obtained by verifying the effect of the correction processing of FIG. 5 according to the embodiment when a transmission wave (CW wave) having a constant frequency is transmitted.

FIG. 14 is a graph showing a verification result obtained by verifying the effect of the correction processing of FIG. 5 according to the embodiment when a transmission wave (FM wave) having a modulated frequency is transmitted.

### DETAILED DESCRIPTION

Example apparatus is described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, may be arranged, substituted, combined, separated, and designed in a wide variety of different configurations, all of which are explicitly contemplated herein.

Hereinafter, an embodiment of this disclosure will be described with reference to the drawings. In the following embodiment, a fish finder is shown as an example of an underwater detection device.

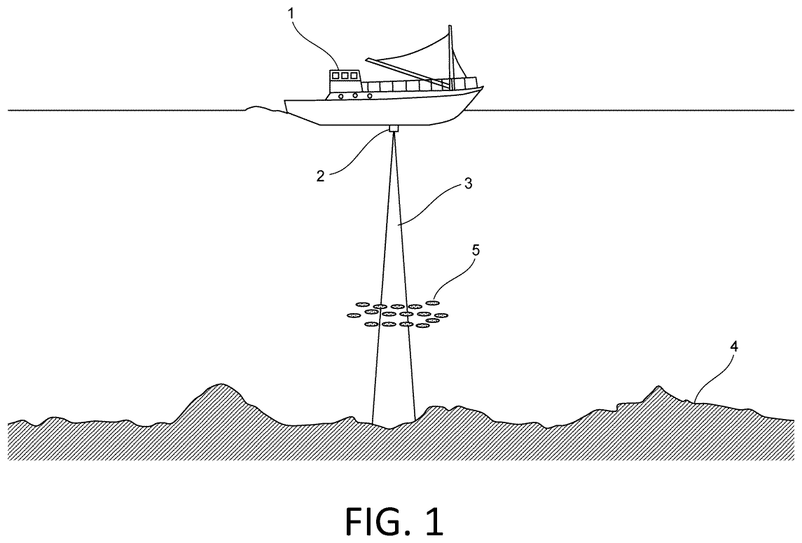

FIG. 1 is a diagram showing an embodiment of the use of the fish finder.

In this embodiment, a transducer 2 is installed on the bottom of a ship 1, and a transmission beam 3 (ultrasound) is transmitted into the water from the transducer 2. The transmission beam 3 has a shape of a cone with a small apex angle, and is transmitted in a pulse shape in a vertically downward direction. The transmission beam 3 is reflected by a bottom 4 and a fish school 5, and the reflected wave (echo) is received by the transducer 2. Echo data, in which the signal intensity of the reception signal is distributed in the detection range in the depth direction, is generated by the reception signal of the reflected wave based on one transmission of the transmission beam 3.

Echo data for a predetermined period are accumulated to generate an echo image showing the distribution of signal intensity (echo intensity) in the depth direction. The echo image includes the intensity distribution of echoes from each target. The generated underwater echo image is displayed on a display unit installed in the wheelhouse of the ship 1. Thus, a user may confirm the target (water bottom 4, fish school 5, etc.) existing underwater.

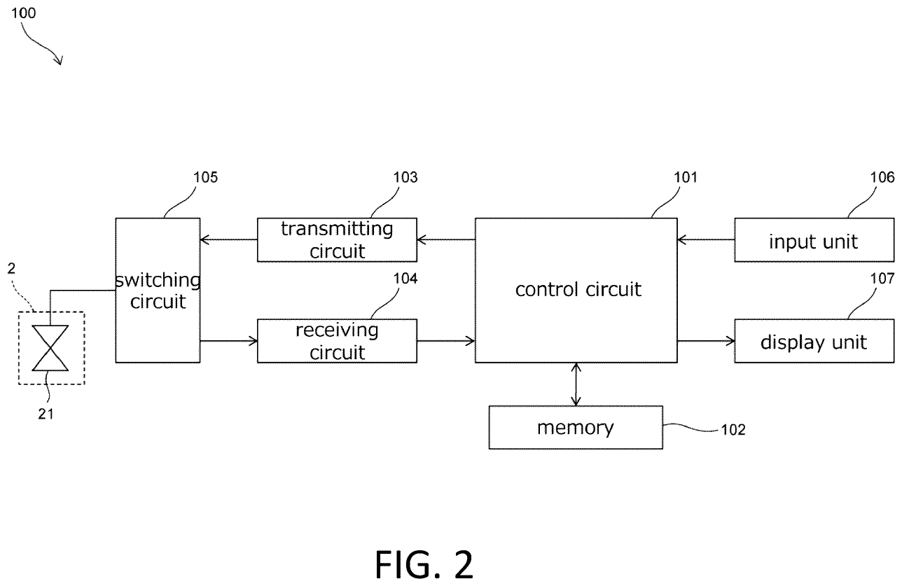

FIG. 2 is a block diagram showing the configuration of a fish finder apparatus 100.

The fish finder apparatus 100 (i.e., the underwater detection device 100) includes the transducer 2 shown in FIG. 1, a control circuit 101, a memory 102, a transmitting circuit 103, a receiving circuit 104, a switching circuit 105, an input unit 106, a display unit 107, and a transmission current measurement circuit 108.

The control circuit 101, the memory 102, the transmitting circuit 103, the receiving circuit 104, the switching circuit 105, the input unit 106, the display unit 107, and the transmission current measurement circuit 108 are installed in the wheelhouse or the like of the ship 1. The configuration except for the transducer 2 may be unitized in one housing, or some of the components such as the display unit 107 may be separated. The switching circuit 105 is communicatively connected to the transducer 2 by a signal cable.

The transducer 2 includes a transmission element used for transmitting ultrasonic waves and a receiving element used for receiving ultrasonic waves. In this embodiment, the transmission element, and the receiving element of the transducer 2 are composed of one ultrasonic transducer 21.

The transmitting circuit 103 generates a transmission signal for driving the ultrasonic transducer 21 from a control signal (control pulse) of a predetermined frequency inputted from the control circuit 101, and outputs the generated transmission signal to the ultrasonic transducer 21 of the transducer 2 via the switching circuit 105.

The ultrasonic transducer 21 transmits a transmission wave (transmission beam 3) by ultrasonic waves into water based on the transmission signal. The ultrasonic transducer 21 also receives a reflected wave of the transmitted transmission wave, and outputs a received signal of a magnitude corresponding to the intensity of the reflected wave to the receiving circuit 104 via the switching circuit 105. The switching circuit 105 switches between transmission and reception of signals to and from the ultrasonic transducer 21.

The receiving circuit 104 includes a filter for extracting the frequency component of the transmission wave from the received signal of the ultrasonic transducer 21, and an amplifying circuit for amplifying the received signal. The receiving circuit 104 generates echo data indicating the echo intensity for each depth based on the received signal of the frequency component extracted by the filter.

More specifically, the receiving circuit 104 generates the echo data that associates the time elapsed since the transmission of the transmission wave (transmission beam 3) with the intensity of the reflected wave, and outputs the generated echo data to the control circuit 101.

Here, the time elapsed since the transmission of the transmission wave corresponds to the depth. The intensity of the reflected wave attenuates as the depth increases. Therefore, the receiving circuit 104 corrects the intensity of the reflected wave, that is attenuated according to the elapsed time, in a way that the attenuation is eliminated, and outputs the corrected echo data to the control circuit 101.

The control circuit 101 includes an arithmetic processing circuit such as a CPU and an integrated circuit such as an FPGA. The memory 102 includes a ROM, a RAM, a hard disk, and the like. The memory 102 stores various programs and information. These programs include a program that causes the control circuit 101 (computer) to execute a function for generating an image by processing the echo data and a function for correcting the pulse width of the control signal (control pulse). The memory 102 is also used as a work area in the processing of the control circuit 101. The control circuit 101 controls each section by a program stored in the memory 102.

The input section 106 includes input means such as a mouse and a keyboard, and receives input from the user. The input section 106 may be a touch panel integrated with the display unit 107. The display unit 107 includes a display such as a CRT monitor or a liquid crystal panel, and displays an image generated by the control circuit 101. As described above, the display unit 107 displays an echo image generated based on the echo data.

The transmission current measurement circuit 108 measures the transmitting current supplied from the transmitting circuit 103 to the transducer 2 (ultrasonic transducer 21). The configuration of the transmission current measurement circuit 108 is the same as that of the transmission current measurement circuit used for measuring the transmitting current of a power supply circuit or the like. The parameters (resistance values, etc.) of the elements of the transmission current measurement circuit 108 are adjusted to match the magnitude of the transmitting current that may be assumed to be supplied to the transducer 2 (ultrasonic transducer 21). The measurement result of the transmission current measurement circuit 108 is input to the control circuit 101 as needed. As described later, the control circuit 101 corrects the pulse width of the control pulse based on the input measurement result of the transmitting current.

The control circuit 101 acquires echo data in which depth is associated with echo intensity for each transmission wave (transmission beam 3). The control circuit 101 generates an echo image based on one frame of continuously acquired echo data and displays it on the display unit 107. The echo image is sometimes called an echogram.

The echo image is an image in which echo intensity is distributed in a coordinate region having depth and time as two axes. In an echo image, each pixel is colored or darkened with a gradation corresponding to the signal intensity of the reflected wave. A user such as a fisherman may grasp the position and range of a school of fish in the water by referring to the echo image displayed on the display unit 107.

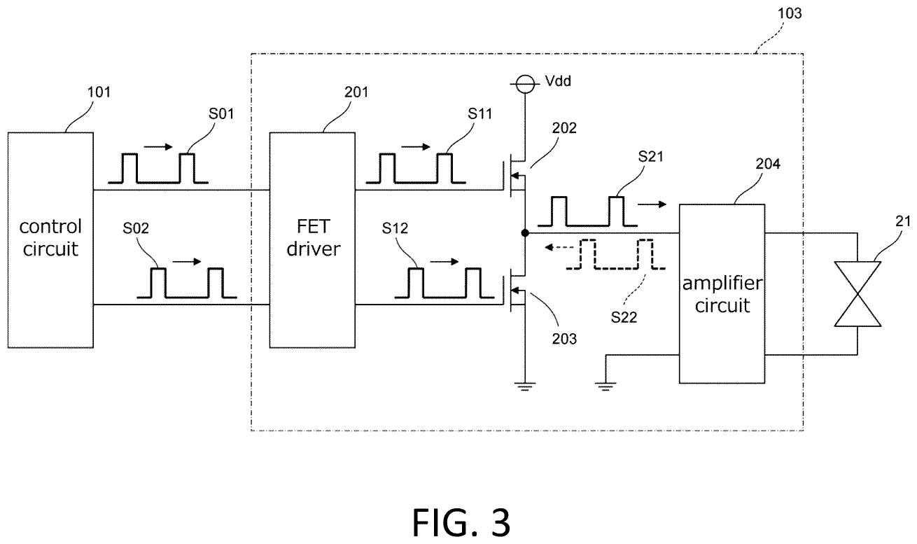

FIG. 3 is a diagram showing a configuration of the transmitting circuit 103.

The transmitting circuit 103 includes a field effect transistor (FET) driver 201, FETs 202 and 203 (field effect transistors), and an amplifier circuit 204. The two FETs 202 and 203 are connected in series between a power supply voltage Ved and ground. The amplifier circuit 204 is connected between the two FETs 202 and 203.

The control circuit 101 outputs control pulses S01 and S02 for driving the FETs 202 and 203 to the FET driver 201. Here, the control pulses S01 and S02 are voltage pulse signals with a constant period, and their phases are shifted by a half period from each other. The FET driver 201 outputs first voltage signals S11 and S12, that are obtained by amplifying the input control pulses S01 and S02, respectively, to the gates of the FETs 202 and 203. As a result, the FETs 202 and 203 are alternately conductive at a predetermined period. The frequencies of the first voltage signals S11 and S12 are the same as the frequencies of the control pulses S01 and S02. Therefore, the operating frequency of the FETs 202 and 203 is also the same as the frequency of the control pulses S01 and S02.

When the upper FET 202 is conductive, the second voltage signal S21, for setting the power supply voltage Ved to a high level, is supplied to the amplifier circuit 204. The frequency of the second voltage signal S21 is the same as the frequency of the control pulse S01.

The amplifier circuit 204 includes a voltage conversion circuit such as a transformer. The amplifier circuit 204 raises or lowers the second voltage signal S21 to generate a transmission signal of a predetermined frequency and supplies the generated transmission signal to the ultrasonic transducer 21. As a result, ultrasonic waves are transmitted from the ultrasonic transducer 21.

By conducting the upper FET 202, the second voltage signal S22 is guided to ground from the amplifier circuit 204. The second voltage signal S22 is a voltage signal remaining in a transformer or the like in the amplifier circuit 204 when the transmission signal is generated. By conducting the FETs 202 and 203 alternately by the first voltage signals S11 and S12, transmission signals of a predetermined frequency are supplied to the ultrasonic transducer 21, and transmission waves of ultrasonic waves are transmitted from the ultrasonic transducer 21.

The transmission wave transmitted from the ultrasonic transducer 21 becomes an AC waveform that is amplified at the same frequency as that of the control pulse S01 by the action of the equivalent circuit of the amplifier circuit 204 and the ultrasonic transducer 21. At this time, the transmitting current flowing through the ultrasonic transducer 21 is also amplified by the same AC waveform. Therefore, in the configuration of FIG. 2, the control circuit 101 may understand the actual amplitude state of the transmission wave from the transmitting current measured by the transmission current measurement circuit 108.

In this embodiment, the pulse width of the control pulse S01 is adjusted in a way that the envelope waveform of the transmission wave (transmission power) transmitted in one transmission period becomes a waveform corresponding to a predetermined window function. As the window function, for example, a Hamming window or a Gaussian window may be used. However, the window function is not limited to these windows. The window function may be appropriately changed according to the purpose.

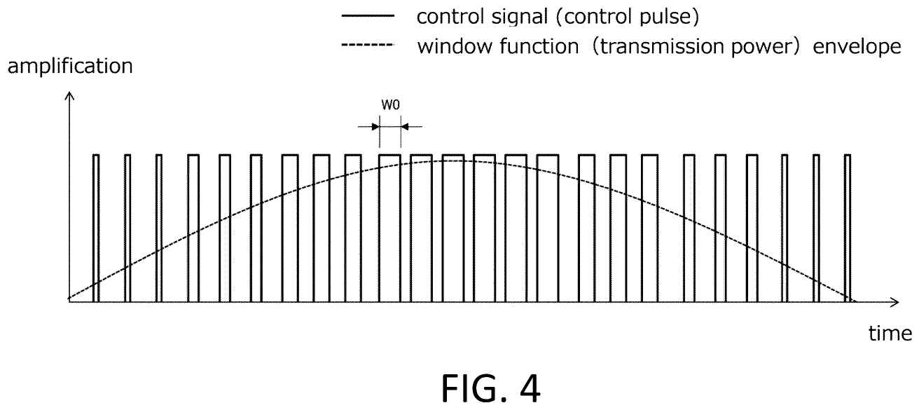

FIG. 4 is a graph schematically showing the relationship between the waveform (ideal waveform) of the window function and the pulse width of the control pulse S01.

FIG. 4 shows the window function and the control pulse in one transmission period. For convenience, 24 control pulses S01 are shown, but the number of actual control pulses S01 is several steps larger. In FIG. 4, the maximum value of the window function shown by the broken line is 1. The amplitude (voltage) of the control pulse S01 is constant. The pulse width of the control pulse S01 increases toward the center of the window function period. Thus, by adjusting the pulse width of the control pulse S01 according to the window function, the transmission wave is transmitted with the transmission power according to the window function.

By the way, in the above configuration, the envelope waveform of the transmission wave may deviate from the ideal envelope waveform. For example, as described above, when the frequency of the transmission wave is constant because the frequency of the control pulse S01 is constant, the envelope waveform of the transmission wave may be distorted depending on the response characteristics of the circuit part constituting the transmitting circuit 103.

Specifically, when the rise characteristics of the FET driver 201 and the FET 202 shown in FIG. 3 are relatively slow, and the pulse width of the control pulse S01 is small, the control pulse S01 turns to a low level before the outputs of the FET driver 201 and the FET 202 completely rise. As a result, the envelope waveform of the transmission wave deviates from the ideal envelope waveform.

Also, the impedance of the transmitting circuit 103 and the ultrasonic transducer 21 changes depending on the frequency of the transmission signal. Therefore, when the frequency of the transmission wave is modulated by modulating the frequency of the control pulse S01, these impedances change according to the modulated frequency. As a result, the envelope waveform of the transmission wave is distorted due to this change in impedance. As a result, the envelope waveform of the transmission wave diverges from the ideal envelope waveform.

Therefore, in the present embodiment, correction for suppressing such divergence is performed in the control circuit 101.

As described above, the transmitting current flowing through the ultrasonic transducer 21 has an amplitude of AC current waveform similar to that of the transmission wave. Therefore, the actual envelope waveform of the transmission wave may be obtained from the transmitting current measured by the transmission current measurement circuit 108. The control circuit 101 obtains the actual envelope waveform of the transmission wave from the measurement result of the transmitting current by the transmission current measurement circuit 108 and corrects the pulse width of the control pulse S01 in a way that the difference between the obtained actual envelope waveform and the ideal envelope waveform is suppressed. This processing will be described below.

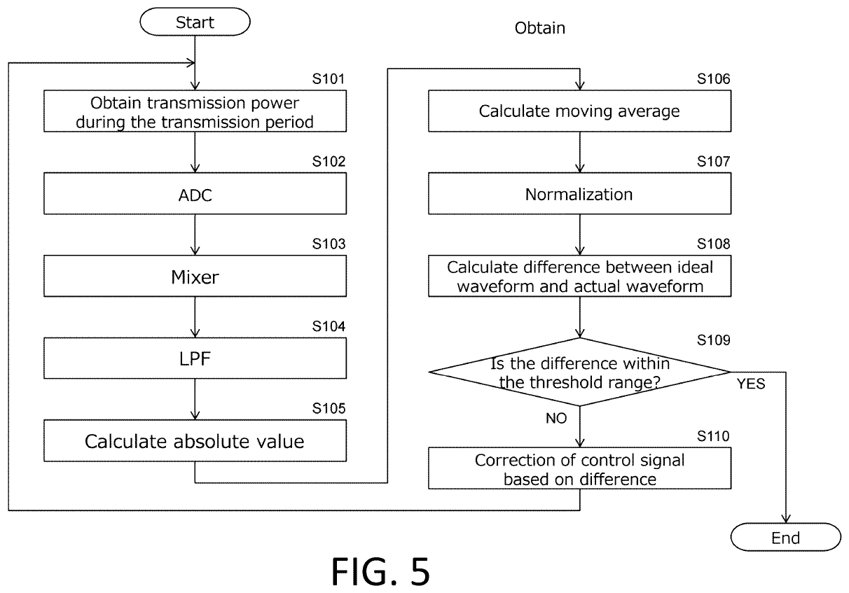

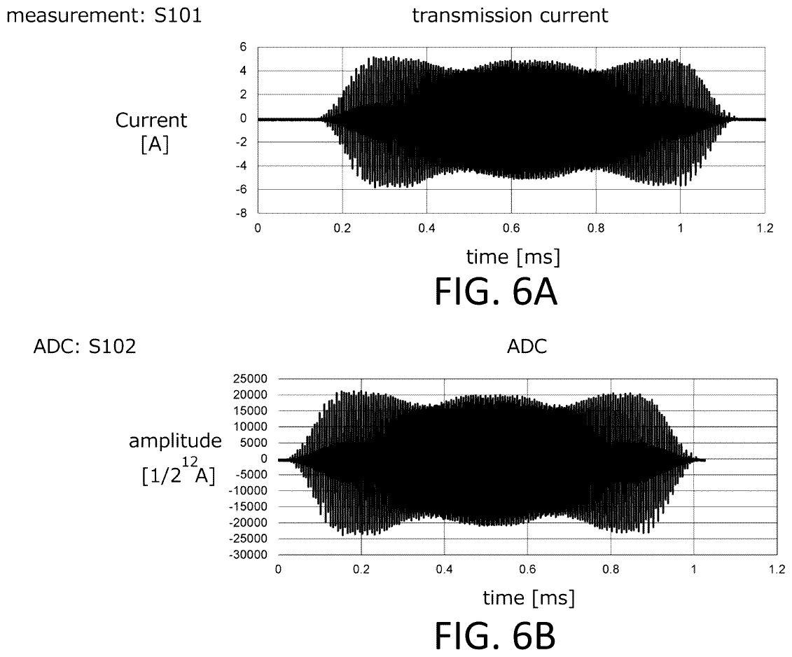

FIG. 5 is a flowchart showing a process for correcting the pulse width of the control pulse S01. FIGS. 6A to 11A are graphs showing examples of waveforms acquired in corresponding steps of the flowchart of FIG. 5. In FIGS. 6A to 11A, step numbers of corresponding steps are appended respectively.

The process of FIG. 5 is performed, for example, when the fish finder apparatus 100 is started. However, the timing at which the process of FIG. 5 is performed is not limited to this, and the process of FIG. 5 may be performed at regular intervals, for example, when the fish finder apparatus 100 is started and during the subsequent operation of the fish finder apparatus 100.

In the correction process, the control circuit 101 first acquires the measurement result of the transmitting current in one wave transmission period from the transmission current measurement circuit 108 (S101). An example of the measurement result of the transmitting current is shown in FIG. 6A. For convenience, FIG. 6A shows the transmitting current in a range slightly wider than the transmission period.

The waveform in FIG. 6A is a measurement of the transmitting current supplied to the ultrasonic transducer 21 using an oscilloscope. FIG. 6B and subsequent sections show a result of processing the measurement result with a predetermined numerical calculation software.

The control circuit 101 performs A/D conversion of the transmitting current in one wave transmission period at a predetermined sampling period, and acquires digital data corresponding to the peak value at each sampling timing (S102). An example of the acquired digital data is shown in FIG. 6B. In FIG. 6B, since the start time of the transmission period is set to 0, the waveform of the digital data is shifted slightly to the left compared to FIG. 6A.

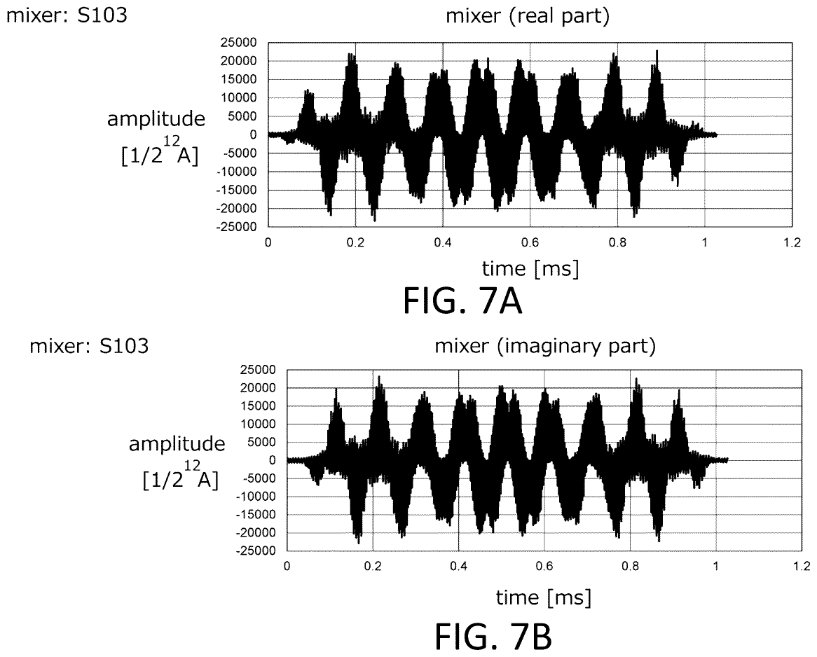

The control circuit 101 executes mixer processing on the acquired digital data (S103). Through this processing, the digital data is dropped into the baseband. The mixer processing calculates real and imaginary digital data. Examples of real and imaginary data when the mixer processing is applied to the digital data of FIG. 6B are shown in FIGS. 7A and 7B, respectively.

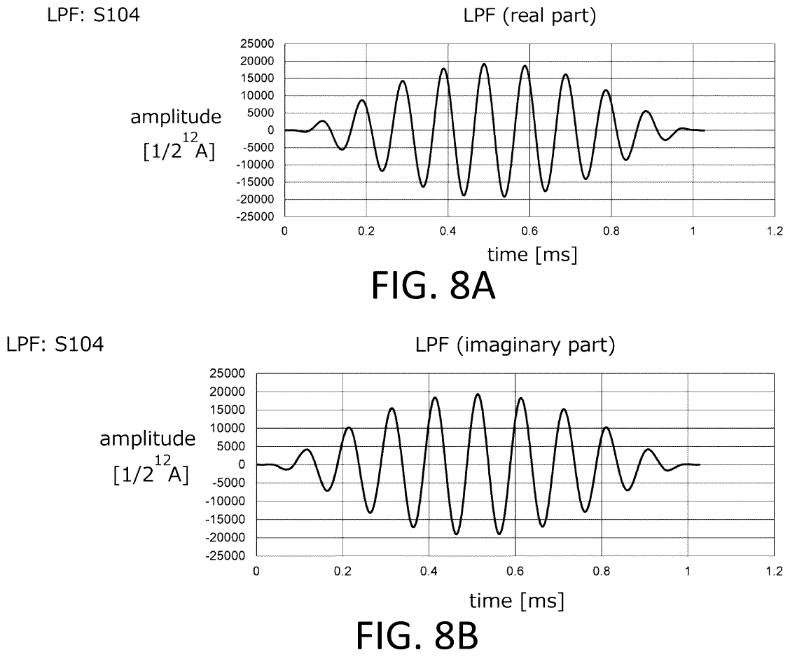

The control circuit 101 applies low-pass filter processing according to the baseband to the real and imaginary data obtained by the mixer processing (S104). As a result, real and imaginary data from which noise components are removed are obtained, respectively. Examples of real and imaginary data subjected to low-pass filter processing are shown in FIGS. 8A and 8B, respectively.

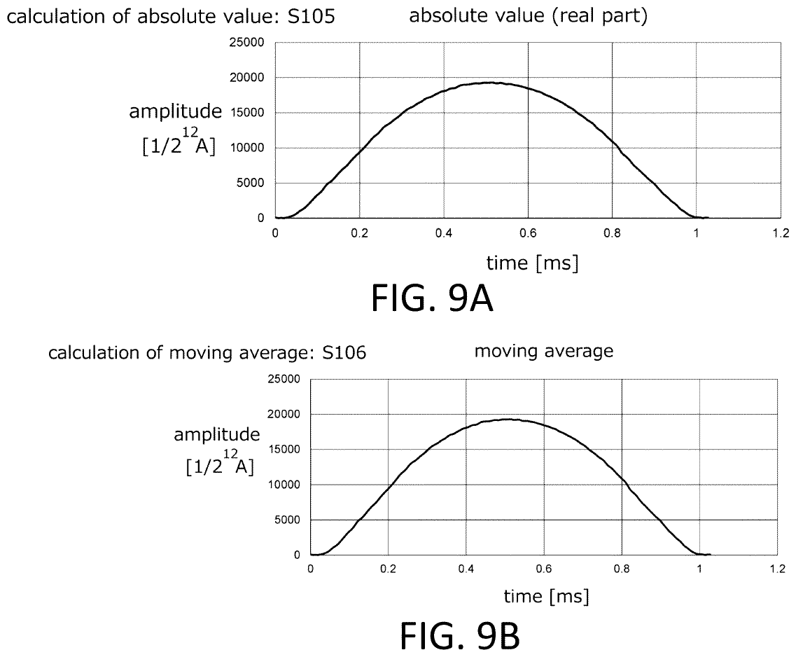

The control circuit 101 multiplies the real and imaginary data subjected to low-pass filter processing for each sampling timing to calculate an absolute value of these data (S105). As a result, waveform data correlated with the window function shown in FIG. 4 is obtained. An example of this data is shown in FIG. 9A.

The control circuit 101 calculates a moving average value along chronological order of the calculated absolute value for each sampling timing (S106). That is, for transmission periods from the current transmission period to a predetermined number of times before, the absolute values of each sampling timing are averaged to calculate a moving average value. The number of transmission periods to which the moving average is applied is set in consideration of variations in the absolute values. If the variations in the absolute values are small, the processing of the moving average (S106) may be omitted. An example of data obtained by the moving average is shown in FIG. 9B.

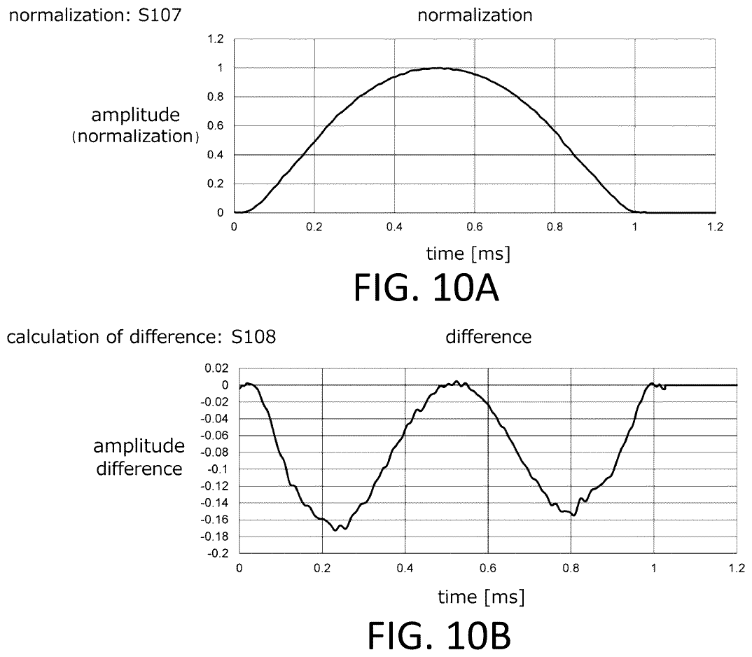

The control circuit 101 performs normalization processing on the data in a way that the peak of the data obtained by the moving average coincides with the peak of the waveform of the window function in FIG. 4 (S107). Here, since the peak value of the waveform of the window function is 1, normalization processing is performed in a way that the peak of the data obtained by the moving average becomes 1. Thus, the waveform based on the normalized data may be contrasted with the waveform of the window function. An example of data subjected to normalization processing is shown in FIG. 10A.

The control circuit 101 calculates the difference between the normalized data (actual envelope waveform) and the waveform of the window function which is the ideal envelope waveform at each sampling timing corresponding to the output of the control pulse S01 (S108). The waveform of the window function which is the ideal envelope waveform is previously stored in the memory 102 of FIG. 2. The difference is calculated because of subtracting the data value of the actual envelope waveform from the data value of the ideal envelope waveform. An example of the data of the difference is shown in FIG. 10B.

The control circuit 101 determines whether or not the differences of all timings are within the threshold range (S109). Here, the threshold range is set to a boundary range where the purpose of applying the envelope to the transmission wave (Suppression of frequency components other than fundamental waves, suppression of range side lobes, etc.) may be substantially achieved if the differences are included in the range.

If all the differences are within the threshold range (S109: YES), the control circuit 101 ends the processing of FIG. 5. On the other hand, if any of the differences is not within the threshold range (S109: NO), the control circuit 101 corrects the pulse width of the corresponding control pulse S01 in a way that the differences are suppressed (S110) and returns the processing to step S101. Thus, according to the control pulse S01 of the corrected pulse width, the processing after step S101 is performed in the next transmission period.

In the correction processing of step S110, the control circuit 101 corrects the pulse width of each control pulse S01 in a way that the deviation of the value, obtained by multiplying the differences by a coefficient (For example, 0.5) smaller than 1 and larger than 0, is eliminated. Thus, excessive correction of the pulse width in the current correction is suppressed, and the differences are gradually suppressed by subsequent corrections.

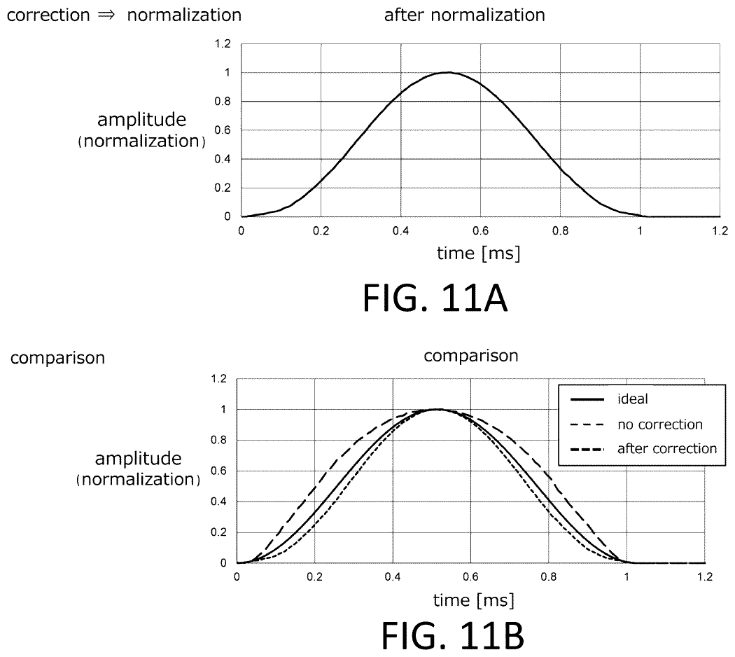

FIG. 11A shows the waveform (waveform corresponding to FIG. 10A of the normalized data obtained by the processing for the next transmission period when the correction is applied. This waveform is obtained when the correction of step S110 is performed with the above coefficient set to 0.5. FIG. 11B shows the waveform of the normalized data obtained by the correction, the waveform of the normalized data before the correction, and the ideal envelope waveform (window function waveform). As shown in FIG. 11B, the waveform of the corrected data is much closer to the ideal envelope waveform (window function waveform) than the waveform of the data before the correction.

In the correction processing of step S110, if there is no fear that excessive correction is performed even if the correction is performed using the difference as it is, the pulse width of each control pulse S01 may be corrected in a way that the difference itself is eliminated without multiplying the difference by the coefficient.

Thus, the control circuit 101 repeatedly executes the processing of steps S101 to S109 and S110 until all the differences are included in the threshold range (S109: NO). Thus, when all the differences are included in the threshold range (S109: YES), the control circuit 101 terminates the processing of FIG. 5.

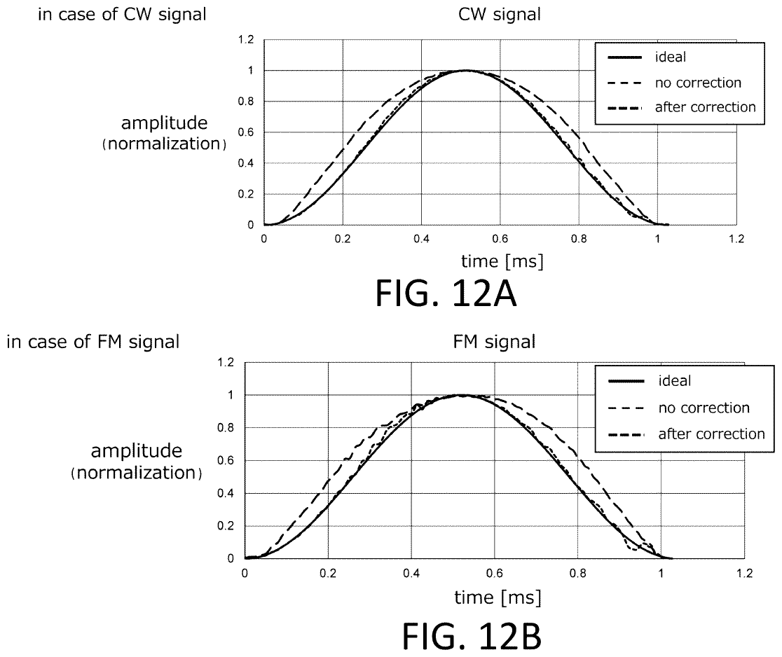

FIG. 12A is a graph showing the waveform of data after normalization processing obtained when correction is performed until all differences are included in the threshold range, the waveform of data after normalization processing before these corrections are performed, and the ideal envelope waveform (waveform of window function). Here, frequency modulation is not applied to the transmission wave.

As shown in FIG. 12A, the waveform of data after these corrections are substantially overlapped with the ideal envelope waveform (waveform of window function). Therefore, by outputting the control pulse S01 at the pulse width after correction, the ultrasonic transducer 21 may transmit the transmission wave with the envelope waveform corresponding to the window function. Therefore, the influence of frequency components other than the fundamental wave may be suppressed.

FIG. 12B is a graph showing the waveform of data after the normalization processing obtained by the correction processing of FIG. 5 when the transmission wave is further frequency-modulated, the waveform of data after the normalization processing when the correction processing is not performed, and the ideal envelope waveform (waveform of window function).

As described above, the frequency modulation of the transmission wave is performed by frequency-modulating a plurality of control pulses S01 included in one transmission period, that is, changing the time interval of adjacent control pulses S01. The receiving circuit 104 includes a matched filter for extracting a signal corresponding to the frequency modulation of the transmission wave from the reception signal. Since the configuration of the receiving circuit 104 for processing the reception signal based on the frequency-modulated transmission wave is well known, a detailed description thereof will be omitted here.

In this transmission mode, the pulse width of a plurality of control pulses S01 included in one transmission period is initialized in a way that the envelope waveform of the transmission wave becomes a waveform corresponding to a predetermined window function. Then, the pulse width of each control pulse S01 is corrected by the correction processing shown in FIG. 5. As a result, the waveform of the data after the normalization processing as shown by the dotted line in FIG. 12B is obtained.

As shown in FIG. 12B, the waveform of the data after the normalization processing obtained when the correction processing shown in FIG. 5 is performed deviates slightly from the ideal envelope waveform (the waveform of the window function) but is almost the same. Therefore, by outputting the control pulse S01 at the pulse width after the correction, the transmission wave may be transmitted to the ultrasonic transducer 21 with the envelope waveform corresponding to the window function. Therefore, the range sidelobe may be suitably suppressed from the waveform of the data obtained by applying the matched filter to the received signal.

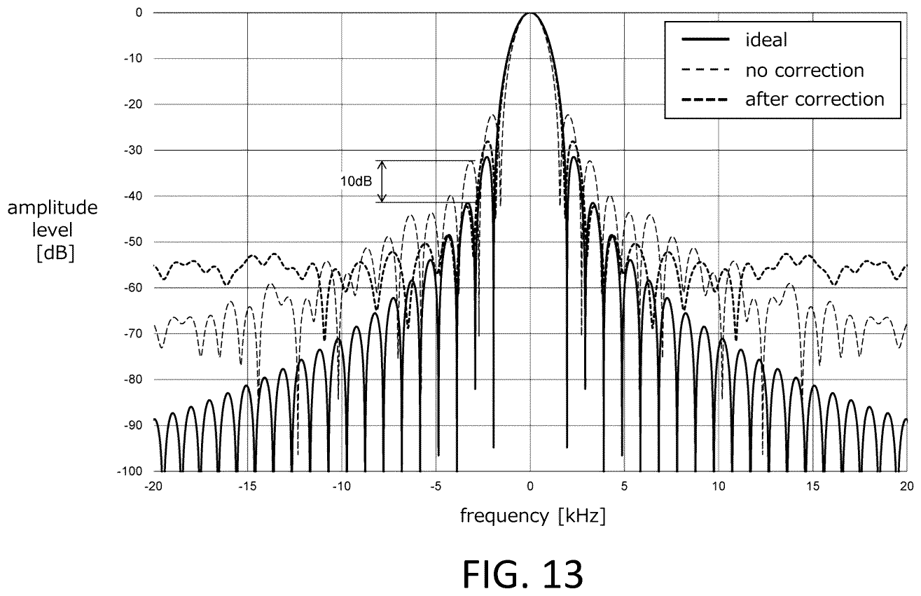

FIG. 13 is a graph showing the results of verification of the effect of the correction processing shown in FIG. 5 when transmission waves (CW waves) of a constant frequency are transmitted.

In this experiment, a transmission wave (ultrasound) was transmitted from the ultrasonic transducer 21 into the water tank, and the pulse width of the control pulse S01 was corrected by the correction processing shown in FIG. 5. The reflected wave when the transmission wave was transmitted into the water tank by the control pulse S01 after correction was received by a microphone to acquire a received signal. Then, a spectrum waveform was acquired by applying Fast Fourier Transform (FFT) to the envelope of the fundamental wave component of the received signal.

The dotted waveform in FIG. 13 shows the spectrum waveform based on the corrected transmission wave. For comparison, FIG. 13 shows the ideal spectrum waveform (solid line) and the spectrum waveform (dashed line) obtained in the same experiment when the correction processing of FIG. 5 was not performed.

As shown in FIG. 13, in the frequency band from −5 kHz to +5 kHz, the spectrum waveform based on the corrected transmission wave substantially overlapped the ideal spectrum waveform. In addition, in this frequency band, the amplitude level deviation of the spectrum waveform based on the corrected transmission wave relative to the ideal spectrum waveform was improved by about 10 dB compared to the case when the correction processing was not performed.

In the frequency band outside ±5 kHz, the spectrum waveform based on the corrected transmission wave deviated from the ideal spectrum waveform. However, this was because the reverberation (harmonic component) generated by the water tank was collected by the microphone because the experiment was conducted in the water tank.

From the above experimental results, we could confirm the effect of the correction processing (Suppressing frequency components other than fundamental waves) shown in FIG. 5 when the transmission wave was a CW wave with constant frequency.

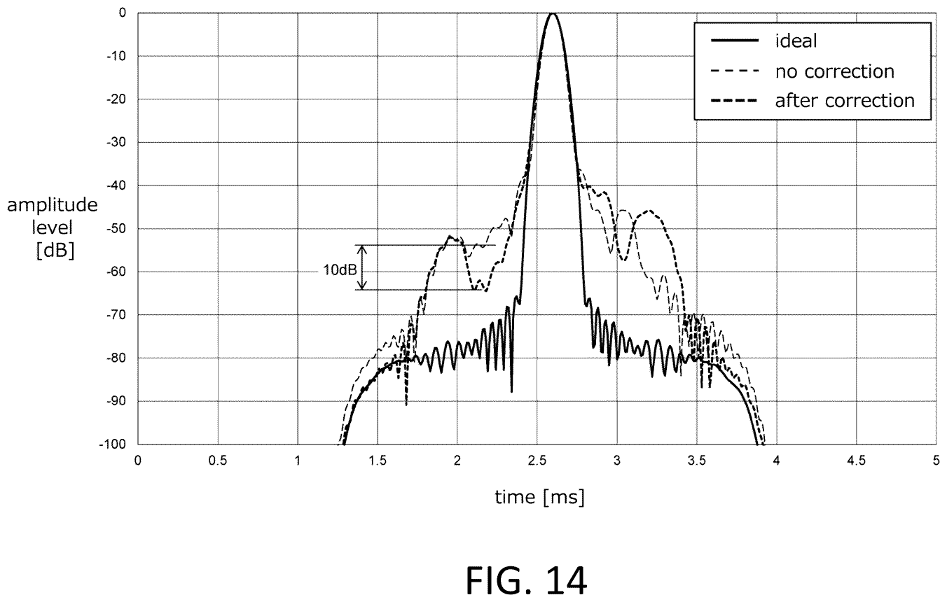

FIG. 14 is a graph showing the results of verification of the effect of the correction processing shown in FIG. 5 when transmission waves (FM waves) with frequency modulation are transmitted.

In this experiment as well, transmission waves (ultrasound) were transmitted from the ultrasonic transducer 21 into the water tank, and the pulse width of the control pulse S01 was corrected by the correction processing shown in FIG. 5. The reflected wave when the transmission wave was transmitted into the water tank by the control pulse S01 after correction was received by the microphone to acquire a received signal. Then, the waveform of the amplitude level of the signal obtained by applying a matched filter to the received signal was acquired.

In FIG. 14, the waveform of the amplitude level based on the corrected transmission wave is indicated by the dotted line. For comparison, FIG. 14 shows the ideal waveform (solid line) and the waveform obtained in the same experiment when the correction processing of FIG. 5 was not performed (dashed line).

In FIG. 14, the time range in which the ideal waveform is near the peak (around 2.4-2.8 msec) corresponds to the time range in which the reflected wave from the water bottom is received. In the experimental results of FIG. 14, in the time range around 2.2-2.4 msec immediately before the correction processing, the range sidelobe generated in the waveform when the correction processing was performed is improved by about 10 dB compared to the case when the correction processing was not performed. Therefore, it was confirmed that when the correction processing of FIG. 5 was performed, it was possible to suppress the reflection of the virtual image based on the range sidelobe in front of the water bottom in the echo image displayed on the display unit 107 of FIG. 2.

In the experimental results of FIG. 14, ridges are generated in the waveform when the correction processing is performed at around 2 msec and around 3.2 msec. However, this is also because the experiment is performed in a water tank (experimental environment), as in the case of FIG. 13.

From the experimental results described above, it is possible to confirm the effect of the correction processing of FIG. 5 (suppression of the range sidelobe) even when the transmission wave is a frequency-modulated FM wave.

According to this embodiment, the following effects are achieved.

As shown in FIG. 5, the control circuit 101 acquires a waveform corresponding to the envelope of the transmission wave output from the ultrasonic transducer 21 based on the transmitting current measured by the transmission current measurement circuit 108 (S101 to S107), calculates the difference between the acquired actual envelope waveform and the ideal envelope waveform (window function waveform) (S108), and corrects the pulse width of the control pulse S01 in a way that the calculated difference is suppressed (S110).

As described above, the envelope waveform of the transmitting current becomes a waveform corresponding to the envelope waveform of the transmission wave being transmitted. Therefore, the waveform corresponding to the actual envelope of the transmission wave may be acquired from the transmitting current. According to the processing of FIG. 5, the pulse width of the control pulse S01 is corrected in a way that the difference between the actual envelope waveform obtained from the transmitting current and the ideal envelope waveform is suppressed. Therefore, as shown in FIG. 11B and FIGS. 12A and 12B, the envelope waveform of the transmission wave transmitted from the ultrasonic transducer 21 may be approximated to the ideal envelope waveform.

As shown in FIG. 5, the control circuit 101 repeatedly executes correction (S110) at least until the difference between the actual envelope waveform and the ideal envelope waveform is within a predetermined threshold range for each control pulse S01 (S109).

Thus, as shown in FIGS. 12A and 12B, the difference between the actual envelope waveform and the ideal envelope waveform may be accommodated within the threshold range for all control pulses S01. Therefore, the divergence between the transmission wave transmitted from the ultrasonic transducer 21 and the ideal envelope waveform may be appropriately suppressed.

Here, the threshold range (S109) is set to a boundary range where the purpose of applying the envelope to the transmission wave (Suppression of frequency components other than fundamental waves, suppression of range side lobes, etc.) may be substantially achieved if the difference is included in the range as described above. Therefore, according to the processing of FIG. 5, the envelope waveform of the corrected transmission wave transmitted from the ultrasonic transducer 21 may be made close to the ideal envelope waveform to the extent that this purpose may be achieved.

As described with reference to FIG. 5, the control circuit 101 corrects the pulse width of each control pulse S01 in a way that the deviation of a value obtained by multiplying the difference by a coefficient (For example, 0.5) smaller than 1 and larger than 0 in each correction (S110) is eliminated.

Thus, the difference is gradually suppressed by each correction (S110), and excessive correction in one correction (S110) may be suppressed. Thus, the difference may smoothly converge within the threshold range.

As described with reference to FIG. 5, the control circuit 101 calculates the moving average of the actual envelope waveform (S106) and calculates the difference between the envelope waveform based on the moving average and the ideal envelope waveform (S107, S108).

According to this configuration, even if a large variation suddenly occurs in the actual envelope waveform, excessive correction (S110) due to this variation may be suppressed. Thus, the envelope waveform of the transmission wave transmitted from the ultrasonic transducer 21 may be smoothly approximated to the ideal envelope waveform.

As shown in FIG. 4, the ideal envelope waveform is a window function waveform that defines the transmission power of the ultrasonic transducer 21. In the processing of FIG. 5, the control circuit 101 calculates the actual envelope waveform by normalizing the envelope waveform acquired from the transmitting current to be contrastable with the window function waveform (S107) and calculates the difference between the calculated actual envelope waveform and the window function waveform (S108).

According to this configuration, the ideal envelope waveform may be easily and accurately set, and the difference between the actual envelope waveform and the ideal envelope waveform may be accurately calculated by the normalization processing for the envelope waveform acquired from the transmitting current. Therefore, the transmission wave transmitted from the ultrasonic transducer 21 may be accurately approximated to the ideal envelope waveform by simple processing.

As shown in FIG. 4, the control circuit 101 outputs a plurality of control pulses S01 at a fixed period in the transmission period of the transmission wave. In this transmission mode, by performing the correction processing of FIG. 5, as shown in FIG. 12A, the envelope waveform of the transmission wave transmitted from the ultrasonic transducer 21 may be made close to the ideal envelope waveform. Therefore, as shown in FIG. 13, frequency components other than the fundamental wave may be suitably suppressed. The control circuit 101 may be configured to output a plurality of frequency-modulated control pulses S01 in the transmission period of the transmission wave.

Also in this transmission mode, by performing the correction process shown in FIG. 5, as shown in FIG. 12B, the transmission wave transmitted from the ultrasonic transducer 21 may be approximated to an ideal envelope waveform. Therefore, as shown in FIG. 14, generation of a range sidelobe in the received signal may be suitably suppressed.

This disclosure is not limited to the above embodiment. The embodiment of this disclosure may be modified in various ways other than the above configuration. For example, in the processing of FIG. 5, the correction processing is terminated because the difference falls within the threshold range (S109), but the processing of step S109 may be omitted, and the correction processing is continued during the operation of the fish finder 100. In this case, the processing proceeds from step S108 to step S110, and the processing of FIG. 5 is terminated when the operation of the fish finder 100 is stopped.

The coefficients applied in the correction of step S110 may not necessarily be uniform, and for example, the coefficients may vary according to the magnitude of the difference. In the above embodiment, the waveform of the window function is used as the ideal envelope waveform for calculating the difference, but another waveform having a correlation with the envelope waveform of the transmission wave may be used as the ideal envelope waveform. For example, the envelope waveform of the transmitting current obtained when the window function is properly applied may be set to the ideal waveform. In this case, step S107 is omitted from the processing of FIG. 5, and in step S108, the difference between the actual envelope waveform of the transmitting current (the waveform of FIG. 9(b)) and the ideal envelope waveform of the transmitting current is calculated.

In the above embodiment, an example of applying this disclosure to the fish finder 100 mounted on the ship 1 is shown, but the application of this disclosure is not limited to this. For example, this disclosure may be applied to a fish finder installed on a fixed net, or to an underwater detection device other than the fish finder, such as a scanning sonar. In addition, the embodiment of this disclosure may be modified in various ways as appropriate.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

1. An underwater detection device for detecting a target in underwater by transmitting an ultrasonic wave from an ultrasonic transducer driven by an ideal transmitting current, comprising:
a control circuit configured to generate a control pulse and output the control pulse, repeatedly;
a transmitting circuit configured to generate a transmission current corresponding to the control pulse and supply the transmitting current to the ultrasonic transducer; and
a transmission current measurement circuit configured to measure the transmitting current;
wherein the control circuit is further configured to:
acquire an actual envelope waveform depending on an envelope of the ultrasonic wave outputted from the ultrasonic transducer, based on the measured transmission current; and
correct a pulse width of the control pulse to suppress a difference between the actual envelope waveform and an ideal envelope waveform, that is obtained based on the ideal transmitting current.

2. The underwater detection device according to claim 1, wherein:
the control circuit is further configured to repeatedly correct the pulse width of the control pulse until the difference is within a predetermined threshold range for each of the control pulse.

3. The underwater detection device according to claim 2, wherein:
the control circuit is configured to correct the pulse width by multiplying the difference by a factor less than 1 and greater than 0 and calculating the pulse width to be corrected.

4. The underwater detection device according to claim 1, wherein:
the control circuit is further configured to:
calculate the moving average of the actual envelope waveform along chronological order, and
correct the pulse width of the control pulse to suppress the difference between the moving average of the actual envelope waveform and the ideal envelope waveform.

5. The underwater detection device according to claim 1, wherein:
the ideal envelope waveform is a waveform of a window function that defines the transmission power of the ultrasonic transducer; and
the control circuit is further configured to:
calculate the actual envelope waveform by normalizing the envelope waveform acquired from the transmission current to be compared with the waveform of the window function; and
calculate the difference between the calculated actual envelope waveform and the waveform of the window function.

6. The underwater detection device according to claim 1, wherein:
the control circuit is configured to output a plurality of the control pulses at a fixed period in the transmission period of the transmission wave.

7. The underwater detection device according to claim 1, wherein:
the control circuit is configured to output a plurality of frequency-modulated control pulses in the transmission period of the transmission wave.

8. The underwater detection device according to claim 1, further comprising:
the ultrasonic transducer configured to:
transmit the ultrasonic wave, driven by an ideal transmitting current; and
receive an echo signal reflected at a target in the underwater.

9. The underwater detection device according to claim 1, further comprising:
a display unit configured to display an echo image based on the echo signal.

10. An underwater detection device control method, comprising:
generating a control pulse;
generating a transmitting current in accordance with the control pulse and measuring the transmitting current;
acquiring the actual envelope waveform depending on the envelope of the ultrasonic wave outputted, based on the measured transmitting current;
correcting the pulse width of the control pulse to suppress the difference between the actual envelope waveform and the ideal envelope waveform obtained based on the ideal transmitting current;
transmitting the corrected control pulse to an ultrasonic transducer to transmit an ultrasonic wave into underwater; and
receiving an echo signal reflected at a target in the underwater.

11. The underwater detection device control method according to claim 10, further comprising:
repeatedly correcting the pulse width of the control pulse until the difference is within a predetermined threshold range for each of the control pulse.

12. The underwater detection device control method according to claim 10, further comprising:
calculating the moving average along chronological order of the actual envelope waveform; and
correcting the pulse width of the control pulse to suppress the difference between the moving average of the actual envelope waveform and the ideal envelope waveform.

13. The underwater detection device control method according to claim 10, wherein:
the ideal envelope waveform is a waveform of a window function that defines the transmission power of the ultrasonic transducer; and
further comprising:
calculating the actual envelope waveform by normalizing the envelope waveform acquired from the transmission current to be compared with the waveform of the window function; and
calculating the difference between the calculated actual envelope waveform and the waveform of the window function.

14. The underwater detection device control method according to claim 10, further comprising:
displaying an echo image based on the echo signal.

15. A non-transitory computer-readable medium having stored thereon computer-executable instructions which, when executed by a computer of an underwater detection device cause the computer of the underwater detection device to execute a function of:
generating a control pulse;
generating a transmitting current in accordance with the control pulse and measuring the transmitting current;
acquiring the actual envelope waveform depending on the envelope of the ultrasonic wave outputted, based on the measured transmitting current;
correcting the pulse width of the control pulse to suppress the difference between the actual envelope waveform and the ideal envelope waveform obtained based on the ideal transmitting current;
transmitting the corrected control pulse to an ultrasonic transducer to transmit an ultrasonic wave into underwater; and
receiving an echo signal reflected at a target in the underwater.
